(19) United States
(12) Patent Application Publication
(10) Pub. No.: US 2025/0205593 A1
(43) Pub. Date: Jun. 26, 2025

(54) GAMING CONTROLLER ASSEMBLY AND GAMING CONTROLLER

(71) Applicant: SANE PRODUCTS INC., Pasadena, CA (US)

(72) Inventor: Pei-Hsun LU, New Taipei City (TW)

(73) Assignee: SANE PRODUCTS INC., Pasadena, CA (US)

(21) Appl. No.: 18/990,305

(22) Filed: Dec. 20, 2024

Related U.S. Application Data
(63) Continuation of application No. 63/614,204, filed on Dec. 22, 2023.

(51) Int. Cl. A63F 13/24; A63F 13/23

(52) U.S. Cl. CPC A63F 13/24; A63F 13/23

(57) ABSTRACT

A gaming controller assembly and a gaming controller, where the gaming controller assembly configured for a portable electronic device to be disposed thereon and including a gaming controller and a mount. The gaming controller includes a host, at least one triggering component and a first magnet. The at least one triggering component is disposed on the host and configured to generate a control signal. The first magnet is disposed on the host. The mount includes a mounting base and a second magnet. The mounting base is configured for the portable electronic device to be disposed thereon. The second magnet is disposed on the mounting base and attracted to the first magnet.

### CROSS-REFERENCE TO RELATED APPLICATIONS

This non-provisional application claims priority under 35 U.S.C. § 119(a) on Provisional Patent Application No(s). 63/614,204 filed in U.S.A. on Dec. 22, 2023, the entire contents of which are hereby incorporated by reference.

### TECHNICAL FIELD

The disclosure relates to a gaming controller assembly and a gaming controller, more particularly to a gaming controller assembly and a gaming controller including at least one magnet.

### BACKGROUND

Recently, with the rapid development of the smartphone, mobile games become more and more popular. In order to improve the user experience for playing the mobile games, some users electrically connect the smartphone to a gaming controller. Also, a mount is usually used to assemble the smartphone and the gaming controller together.

However, due to the structural design of the conventional mount, assembling the smartphone and the gaming controller by the mount includes complex process, such as the installation or removal of one or more screws.

### SUMMARY

The disclosure provides a gaming controller assembly and a gaming controller allowing the gaming controller and a portable electronic device to be assembled together by a mount in a convenient manner.

One embodiment of this disclosure provides a gaming controller assembly configured for a portable electronic device to be disposed thereon and including a gaming controller and a mount. The gaming controller includes a host, at least one triggering component and a first magnet. The at least one triggering component is disposed on the host and configured to generate a control signal. The first magnet is disposed on the host. The mount includes a mounting base and a second magnet. The mounting base is configured for the portable electronic device to be disposed thereon. The second magnet is disposed on the mounting base and attracted to the first magnet.

Another embodiment of this disclosure provides a gaming controller including a host, at least one triggering component and a magnet. The at least one triggering component is disposed on the host and configured to generate a control signal. The magnet is disposed on the host.

According to the gaming controller assembly and the gaming controller discussed above, since the gaming controller includes the first magnet (magnet) disposed on the host, the first magnet is attracted to the second magnet disposed on the mounting base, thereby assembling the gaming controller and the mount to each other. Thus, the gaming controller and the mount is allowed to be assembled together in a convenient manner by magnetic attraction.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a gaming controller assembly according to one embodiment of the disclosure;

FIG. 2 is a partial exploded view of the gaming controller assembly in FIG. 1;

FIG. 3 is the gaming controller assembly in FIG. 2 from another viewing angle;

FIG. 4 is a partially enlarged cross-sectional view of the gaming controller assembly in FIG. 1;

FIG. 5 is another partial exploded view of the gaming controller assembly in FIG. 1; and

FIG. 6 is the gaming controller assembly in FIG. 8 from another viewing angle.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

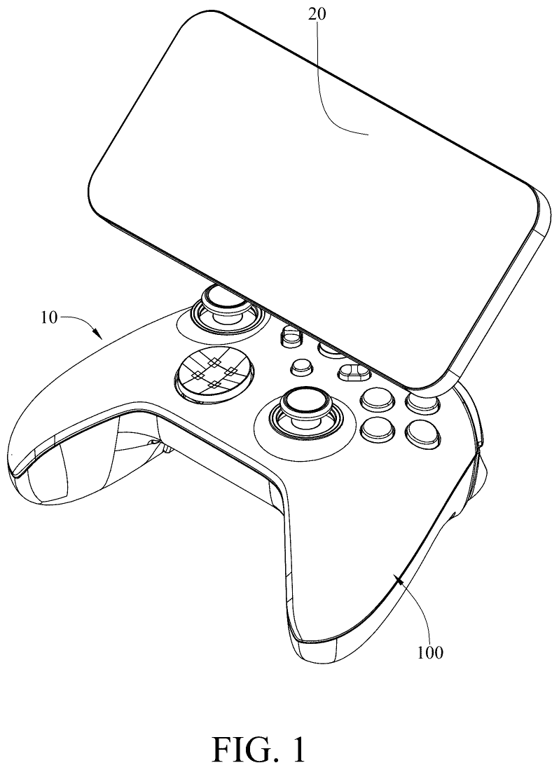

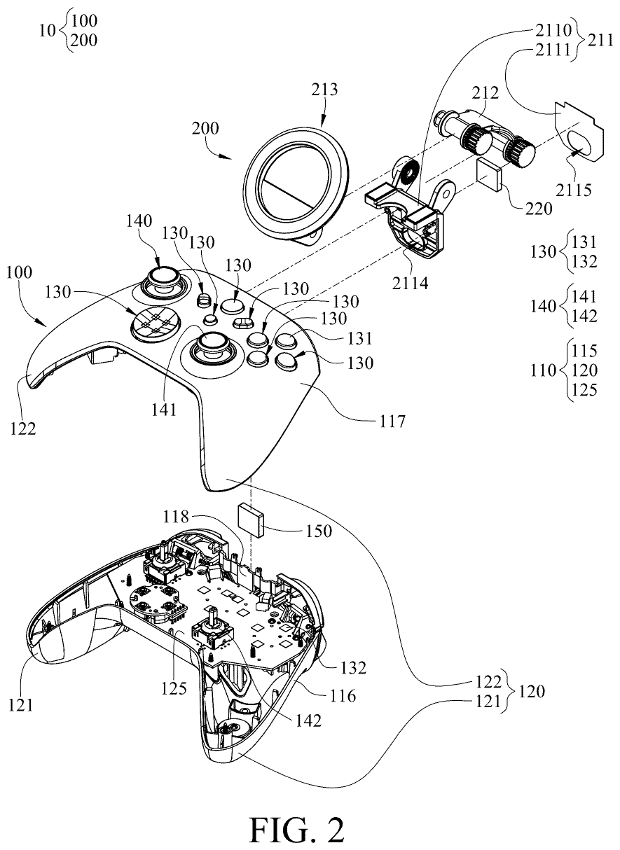

Please refer to FIGS. 1 and 2. FIG. 1 is a perspective view of a gaming controller assembly 10 according to one embodiment of the disclosure. FIG. 2 is a partial exploded view of the gaming controller assembly 10 in FIG. 1. In this embodiment, the gaming controller assembly 10 is configured for a portable electronic device 20 to be disposed thereon and includes a gaming controller 100 and a mount 200. The portable electronic device 20 is, for example, a smartphone, but the disclosure is not limited thereto. In other embodiments, the portable electronic device may be a handheld gaming console or any other suitable type of portable electronic device.

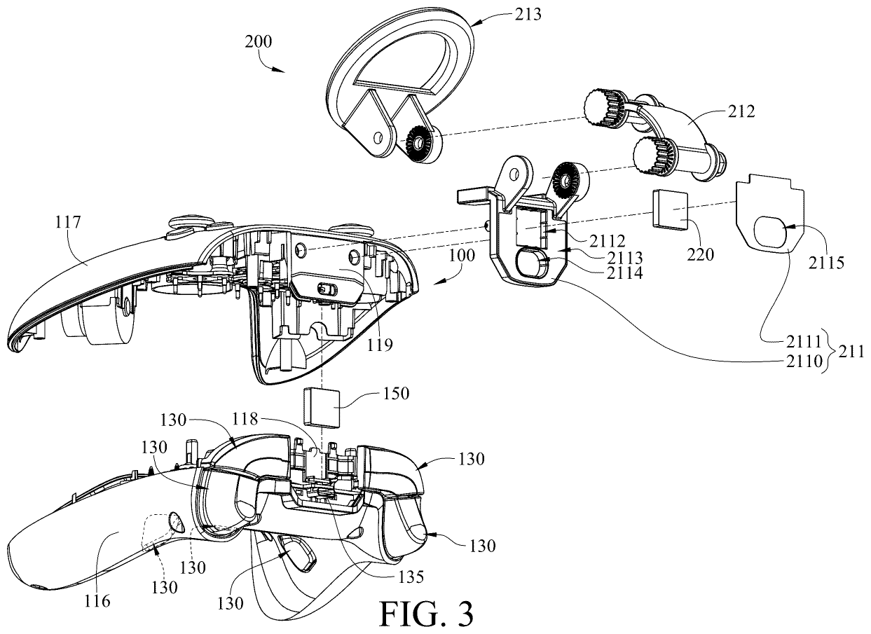

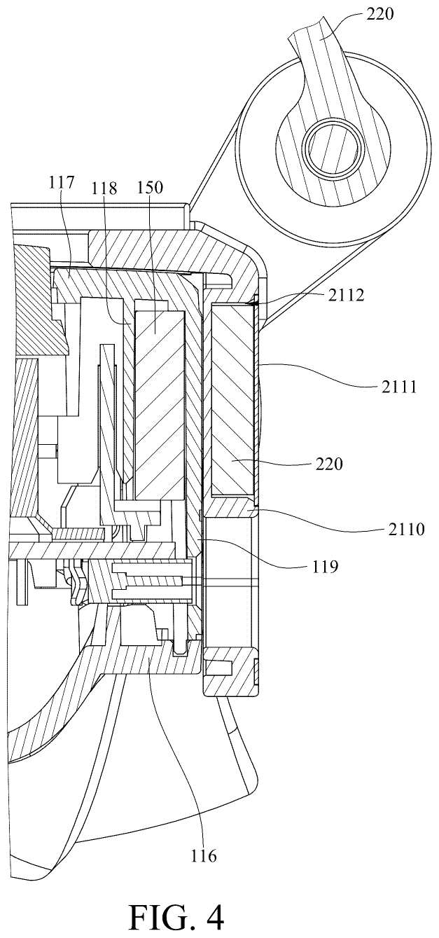

Please refer to FIGS. 2 to 4. FIG. 3 is the gaming controller assembly 10 in FIG. 2 from another viewing angle. FIG. 4 is a partially enlarged cross-sectional view of the gaming controller assembly 10 in FIG. 1. In this embodiment, the gaming controller 100 includes a host 110, a plurality of first triggering components 130, a plurality of second triggering components 140 and a first magnet 150.

In this embodiment, the host 110 includes, for example, a housing 115, two handheld bodies 120, and a circuit assembly 125. The housing 115 includes, for example, a base 116, a cover 117, a supporting plate 118 and a blocking plate 119. The cover 117 is disposed on a side of the base 116. The cover 117 and the base 116 together form an accommodation space S. The two handheld bodies 120 protrude from the same side of the housing 115, and spaced apart from each other. In detail, the two handheld bodies 120 each comprise a first handheld part 121 and a second handheld part 122 that protrude from a side of the base 116 and a side of the cover 117, respectively. The supporting plate 118 is connected to a side of the base 116 located away from the first handheld parts 121. The blocking plate 119 is connected to a side of the cover 117 located away from the second handheld parts 122. The circuit assembly 125 is located in the accommodation space S. The circuit assembly 125 is, for example, a motherboard.

The first triggering components 130 are, for example, buttons. Each first triggering component 130 includes, for example, a pressed part 131 and an inching switch 132. The pressed part 131 is movably disposed on the cover 117. The inching switch 132 is disposed on and electrically connected to the circuit assembly 125. The pressed part 131 is configured to be pressed to trigger the inching switch 132 to generate a control signal and transfer the same to the circuit assembly 125.

The second triggering components 140 are, for example, joysticks. Each second triggering component 140 includes, for example, a pressed part 141 and an inching switch 142. The pressed part 141 is movably disposed on the cover 117. The inching switch 142 is disposed on and electrically connected to the circuit assembly 125. The pressed part 141 is configured to be moved to trigger the inching switch 142 to generate a control signal and transfer the same to the circuit assembly 125.

The control signals generated by the first triggering components 130 or the second triggering components 140 may correspond to various button functions in mobile games, such as firing, running, moving, rotating camera, jumping, reloading, scrolling items and the like.

In other embodiments, the gaming controller may include one first triggering component and may not include the second triggering component, or may include one second triggering and may not include the first triggering component.

For example, the first magnet 150 is disposed on the supporting plate 118 via adhering. Also, the two handheld bodies 120 and the first magnet 150 are located on two opposite sides of the housing 115, respectively. In addition, the blocking plate 119 is located on a side of the first magnet 150 located away from the supporting plate 118.

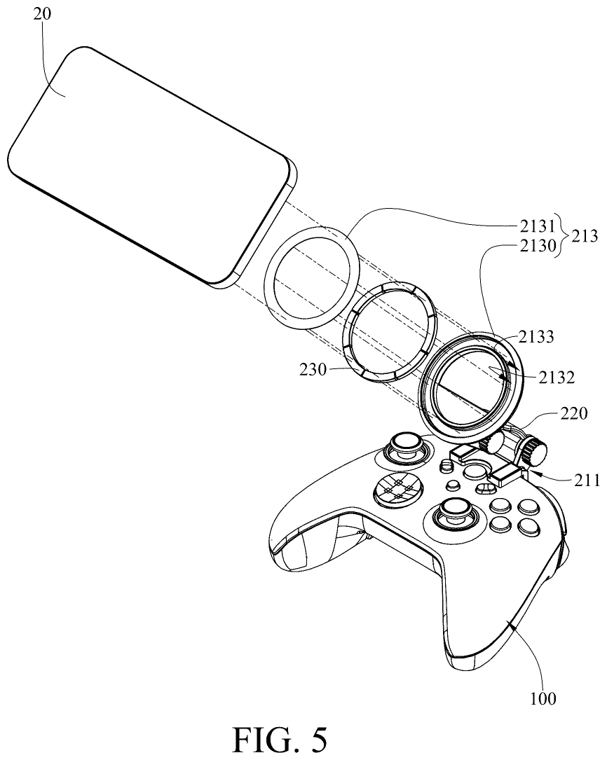

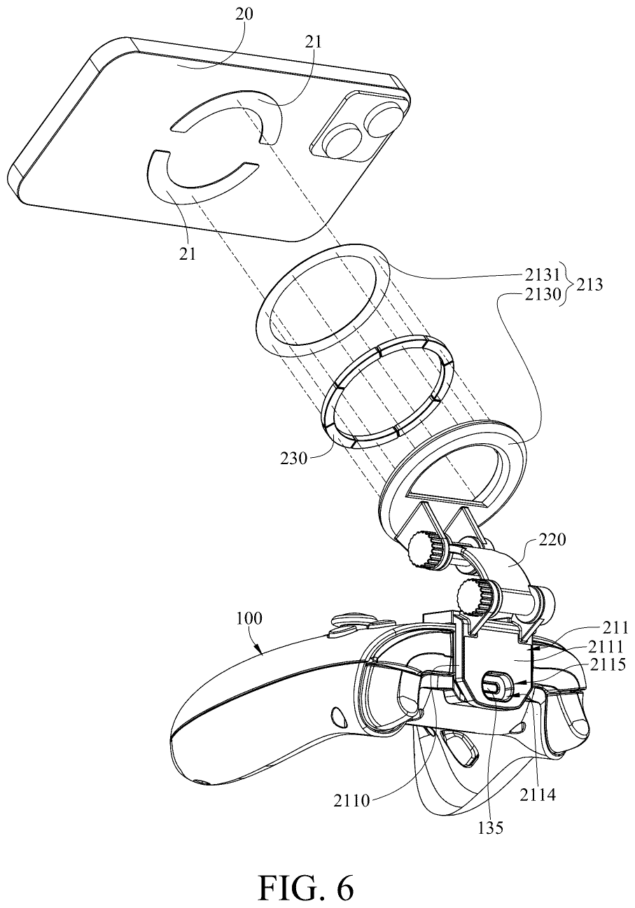

Please refer to FIGS. 2 to 6. FIG. 5 is another partial exploded view of the gaming controller assembly 10 in FIG. 1. FIG. 6 is the gaming controller assembly 10 in FIG. 8 from another viewing angle.

In this embodiment, the mount 200 includes a mounting base 210 and a second magnet 220 and a third magnet 230.

As shown in FIGS. 2 to 4, the mounting base 210 includes, for example, a first mounting body 211, a second mounting body 213 and a connecting structure 212. The first mounting body 211 and the second mounting body 213 are movably disposed on two different sides of the connecting structure 212, respectively. For example, the first mounting body 211 and the second mounting body 213 are pivotally connected to two different sides of the connecting structure 212, respectively. Thus, the portable electronic device 20 may be moved to any desired angle relative to the gaming control 100 via the pivotal connection between the first mounting body 211 and the second mounting body 213 and the connecting structure 212.

As shown in FIGS. 2 to 4, in this embodiment, the first mounting body 211 includes a mounting plate 2110 and a cover plate 2111. The cover plate 2111 is disposed on a side of the mounting plate 2110. The mounting plate 2110 is disposed on the base 116 and cover 117 of the housing 115. The mounting plate 2110 has a recess 2112 located on a top surface 2113 of the mounting plate 2110 facing away from the host 110. The second magnet 220 is located in the recess 2112 and attracted to the first magnet 150. Also, the second magnet 220 is fixed to the mounting plate 2110 via, for example, adhering. The cover plate 2111 covers the second magnet 220.

The blocking plate 119 prevents the first magnet 150 from being detached from the housing 115 (e.g., supporting plate 118) due to the strong attraction between the first magnet 150 and the second magnet 220, and the mounting plate 2110 prevents the second magnet 220 from being detached from the first mounting body 211 (e.g., the mounting plate 2110) due to the strong attraction between the first magnet 150 and the second magnet 220. In detail, when the mount 200 is detached from the gaming controller 100, the magnetic force generated between the first magnet 150 and the second magnet 220 moves the same toward each other. At this time, the blocking plate 119 contacts a side of the first magnet 150 located close to the second magnet 220, and thus prevents the first magnet 150 from being detached from the housing 115 due to the attraction of the second magnet 220. Similarly, the mounting plate 2110 contacts a side of the second magnet 220 located close to the first magnet 150, and thus prevents the second magnet 220 from being detached from the first mounting body 211 due to the attraction of the first magnet 150. Thus, the gaming controller 100 is allowed to be firmly assembled to the mount 200 without reducing the durability of the gaming controller assembly 10.

In addition, as shown in FIG. 4, the mounting plate 2110 is located on a side of the blocking plate 119 located away from the first magnet 150, and thus the first magnet 150 is further prevented from being detached from the supporting plate 118.

Note that the disclosure is not limited by the position of the first magnet 150. In other embodiments, the first magnet may be located in a recess that is located on a side of the base that is located away from the cover, a recess that is on a side of the base or the cover that is located away from the handheld body, or any other suitable position enable the stable attraction between the first magnet and the second magnet.

The mounting plate 2110 may have a through hole 2114 and the cover plate 2111 may have a through hole 2115. As shown in FIGS. 3 and 6, a connector 135 of the circuit assembly 125 is exposed to the outside from the through holes 2114 and 2115. The circuit assembly 125 may be electrically connected to the portable electronic device 20 by wireless communication or cable (not shown). When the circuit assembly 125 is electrically connected to the portable electronic device 20 by cable, the cable may be disposed through the through holes 2114 and 2115 and plugged into the connector 135. In other embodiments, the mounting plate and the cover plate may not have the through hole and the circuit assembly may be electrically connected to the portable merely via wireless communication.

As shown in FIGS. 4-6, in this embodiment, the second mounting body 213 includes, for example, a mounting plate 2130 and a cover plate 2131. The cover plate 2131 is disposed on a side of the mounting plate 2130. The mounting plate 2130 is pivotally connected to a side of the connecting structure 212. The mounting plate 2130 has a recess 2132 located on a top surface 2133 of the mounting plate 2130 facing away from the connecting structure 212. The third magnet 230 is located in the recess 2132, and is configured to be attracted to one or more external magnets 21 of the portable electronic device 20. The cover plate 2131 covers the third magnet 230, and is configured for the portable electronic device 20 to be disposed thereon. The mounting plate 2130 may be in a ring shape. The cover plate 2131 may be in an arc shape. The third magnet 230 may be a single magnet in a ring shape or may include multiple magnets arranged in a ring shape.

According to the gaming controller assembly and the gaming controller discussed above, since the gaming controller includes the first magnet (magnet) disposed on the host, the first magnet is attracted to the second magnet disposed on the mounting base, thereby assembling the gaming controller and the mount to each other. Thus, the gaming controller and the mount is allowed to be assembled together in a convenient manner by magnetic attraction.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A gaming controller assembly, configured for a portable electronic device to be disposed thereon and comprising:
a gaming controller, comprising:
a host;
at least one triggering component, disposed on the host and configured to generate a control signal; and
a first magnet, disposed on the host; and
a mount, comprising:
a mounting base, configured for the portable electronic device to be disposed thereon; and
a second magnet, disposed on the mounting base and attracted to the first magnet.

2. The gaming controller assembly according to claim 1, wherein the mounting base comprises a first mounting body, a second mounting body and a connecting structure, the first mounting body and the second mounting body are movably disposed on two different sides of the connecting structure, respectively, the second magnet is disposed on the first mounting body, and the second mounting body is configured for the portable electronic device to be disposed thereon.

3. The gaming controller assembly according to claim 2, wherein the first mounting body comprises a mounting plate and a cover plate, the cover plate is disposed on a side of the mounting plate, the mounting plate is disposed on the host, the mounting plate has a recess located on a top surface of the mounting plate facing away from the host, the second magnet is located in the recess, and the cover plate covers the second magnet.

4. The gaming controller assembly according to claim 3, wherein the host comprises a housing, two handheld bodies, and a circuit assembly, the two handheld bodies protrude from a side of the housing, the circuit assembly is disposed in the housing and electrically connected to the at least one triggering component, the at least one triggering component is disposed on the housing, and the first magnet is disposed on the housing.

5. The gaming controller assembly according to claim 4, wherein the two handheld bodies and the first magnet are located on two opposite sides of the housing, respectively.

6. The gaming controller assembly according to claim 5, wherein the housing comprises a base and a cover, the cover is disposed on a side of the base, the cover and the base together form an accommodation space, the circuit assembly is located in the accommodation space, the two handheld bodies each comprise a first handheld part and a second handheld part that protrude from a side of the base and a side of the cover, respectively.

7. The gaming controller assembly according to claim 6, wherein the housing further comprises a supporting plate and a blocking plate, the supporting plate is connected to a side of the base located away from the first handheld parts, the first magnet is disposed on the supporting plate, the blocking plate is connected to a side of the cover located away from the second handheld parts, the blocking plate is located on a side of the first magnet located away from the supporting plate, and the mounting plate is located on a side of the blocking plate located away from the first magnet.

8. The gaming controller assembly according to claim 2, wherein the first mounting body and the second mounting body are pivotally connected to two different sides of the connecting structure, respectively.

9. The gaming controller assembly according to claim 2, wherein the mount further comprises a third magnet disposed on the second mounting body, the third magnet is configured to be attracted to an external magnet of the portable electronic device.

10. The gaming controller assembly according to claim 9, wherein the second mounting body comprises a mounting plate and a cover plate, the cover plate is disposed on a side of the mounting plate, the mounting plate is movably disposed on a side of the connecting structure, the mounting plate has a recess located on a top surface of the mounting plate facing away from the connecting structure, the third magnet is located in the recess, and the cover plate covers the third magnet.

11. A gaming controller comprising:
a host;
at least one triggering component, disposed on the host and configured to generate a control signal; and
a magnet, disposed on the host.

12. The gaming controller according to claim 11, wherein the host comprises a housing, two handheld bodies, and a circuit assembly, the two handheld bodies protrude from a side of the housing, the circuit assembly is disposed in the housing and electrically connected to the at least one triggering component, the at least one triggering component is movably disposed on the housing, and the magnet is disposed on the housing.

13. The gaming controller according to claim 12, wherein the two handheld bodies and the magnet are located on two opposite sides of the housing, respectively.

14. The gaming controller according to claim 13, wherein the housing comprises a base and a cover, the cover is disposed on a side of the base, the cover and the base together form an accommodation space, the circuit assembly is located in the accommodation space, the two handheld bodies each comprise a first handheld part and a second handheld part that protrude from a side of the base and a side of the cover, respectively.

15. The gaming controller according to claim 14, wherein the housing further comprises a supporting plate and a blocking plate, the supporting plate is connected to a side of the base located away from the first handheld parts, the magnet is disposed on the supporting plate, the blocking plate is connected to a side of the cover located away from the second handheld parts, and the blocking plate is located on a side of the magnet located away from the supporting plate.
